(19) United States
(12) Patent Application Publication
(10) Pub. No.: US 2003/0206646 A1
(43) Pub. Date: Nov. 6, 2003

(54) Imaging system having means for creating, managing and selecting from list of exam descriptions

(76) Inventor: Charles C. Brackett, Brookfield, WI (US)

Correspondence Address: OSTRAGER CHONG & FLAHERTY LLP, 825 THIRD AVE, 30TH FLOOR, NEW YORK, NY, 10022-7519, US

(21) Appl. No.: 09/557,153

(22) Filed: Apr. 24, 2000

(51) Int. Cl. G06F 17/60; G06K 9/00

(52) U.S. Cl. 382/128; 705/2

(57) ABSTRACT

Method and apparatus for configuring computer tasks which construct data objects. The system user is able to configure these tasks by the simple expedient of clicking on a toggle switch displayed on a user interface screen or menu. In response to operation of the toggle switch, a selected one of a pair of attribute control files associated with the particular task will be utilized during object construction. The menu contains a list of the activated configured remote devices for the particular imaging system. Next to each device name is a virtual toggle switch (defaulted to OFF). In the OFF state, the task will be configured in accordance with the first attribute control file which is compliant with a first communications standard. If the user toggles the switch for a particular device to ON (this can be done on a per device basis), then the task will be configured in accordance with the second attribute control file which is compliant with a second communications standard. By toggling switches on the menu, the user is able to tell the system which attribute control file to use (to configure a task) for which remote device.

### FIELD OF THE INVENTION

This invention generally relates to imaging systems used in medical diagnostics. In particular, the invention relates to the transfer of digital images from an ultrasound imaging system over a network to remote devices for archiving, viewing and/or printing.

### BACKGROUND OF THE INVENTION

Conventional ultrasound imagers create two-dimensional images of biological tissue by scanning a focused ultrasound beam in a scan plane and for each transmitted beam, detecting the ultrasound wave energy returned along a respective scan line in the scan plane. If the ultrasound probe is swept over an area of body, a succession of image frames (corresponding to spaced slices intersecting the body being examined) can be displayed on the monitor. In one type of ultrasound imaging system, a long sequence of the most recent images are stored and continuously updated automatically in a cine memory on a first-in, first-out basis. The cine memory acts as a buffer for transfer of images to digital archival devices via the host computer. When the user freezes the system (by operation of an appropriate device on an operator interface), the user has the capability to view image data previously captured in cine memory. Any acquired or projected image can be stored internally on the system hard disk or on a magneto-optical disk (MOD) inserted in a disk drive.

In addition to storing images internally, modern imaging systems need to be able to transfer images to various types of remote devices via a communications network. To successfully transfer images, the relevant networking features of the imager must be compatible with the networking features of the destination remote device. In particular, the imager must place the data to be transferred in a format which can be handled by the destination remote device. An attempt to accomplish the foregoing is the adoption of the DICOM (Digital Imaging and Communications in Medicine) standards, which specify the conformance requirements for the relevant networking features. The DICOM standards are intended for use in communicating medical digital images among printers, workstations, acquisition modules (such as an ultrasound imaging system) and file servers. The acquisition module is programmed to transfer data in a format which complies with the DICOM standards, while the receiving device is programmed to receive data which has been formatted in compliance with those same DICOM standards.

The DICOM system is based on the client/server concept. The device which uses a service (on objects) is the client device, while the device which provides the service is the server device. The client device is referred to as a Service Class User (SCU), while the server device is referred to as a Service Class Provider (SCP). The SCU sends a Service Request to the SCP over a local area network (LAN). The SCP sends back a response to the SCU over the same LAN. If the response is affirmative and a communications syntax is agreed upon, an association between the SCU and the SCP is opened and data can be transferred between the two devices. In the DICOM system a device is not limited to one role: it can be both SCU and SCP at different times.

The DICOM system is designed to facilitate the communication of digital images of different types, e.g., X-ray, computerized tomography, magnetic resonance and ultrasound imaging. In an ultrasound imager having conventional DICOM capability, three local real-world activities occur: Image Send, Image Print and Remote Verification. Image Send and Image Print can be done in either automatic or manual mode. Verification of remote DICOM devices configured on the ultrasound imager is performed when the imager is powered up or when requested by the system operator.

All DICOM activities are handled in a queued manner by application software running on a host computer incorporated in the imager. In one type of ultrasound imager, the user can select any image in cine memory to be sent in DICOM format via a LAN to a remote device having DICOM capability. The host computer of the ultrasound imaging system is programmed with DICOM system software which facilitates transmission of image frames from the cine memory to the remote DICOM device via the host computer hard disk and the LAN. The transfer is done in the background while scanning or other operator activities continue.

In order to accomplish image transfer, the ultrasound imaging system must know the configuration of the destination remote device prior to attempting to communicate with that device. The configuration data for the destination remote device is typically inputted to the ultrasound imager during software installation by a field engineer, although the DICOM network can be configured at any time. When the imager receives an instruction to transmit data to a particular remote device from the system operator, the imager software converts the image data to be transferred into the DICOM format required by the destination remote device, based on the configuration data for that device stored in system memory. The imager also sends a request over the network to the destination remote device to open an association, i.e., to connect the imager to the destination remote device. If the remote device responds in the affirmative, the imager and remote device then agree on which device will act as the server and which as the client. The ultrasound imager also selects the appropriate encoding syntax from those accepted by the remote device. Other communication parameters are also negotiated.

After the DICOM communications protocol has been settled, the association is opened and the imager attempts to send the DICOM-formatted image file (object) to the remote device via the network. If the remote device is a storage device, each image file is transferred singly in response to a Send request inputted by the operator. If the remote device is a printer configured to print multi-image film, then a number of images are accumulated to make up a multi-image film and an association is opened in response to a Send instruction when a number of images sufficient to fill the multi-image film have been accumulated.

In addition to the digitized image (i.e., pixel data), the DICOM object transferred from the ultrasound imager also includes attribute information. For example, the attribute information may include patient attributes (e.g., patient name and patient identification number), exam attributes (e.g., exam description and exam date), series attributes (e.g., modality type and series date), and image attributes (e.g., image type and numbers of rows and columns). Each attribute has a name, a value representation and a tag. A tag is a number unique to the attribute, e.g., (0040,0100), and is used to identify the attribute. (Different systems use different tags for the same attribute name, which gives rise to incompatibility, as described in more detail hereinafter.) The value representation defines what type of value the attribute can have (e.g., a 64-character string, binary data, etc.).

Many Picture Archiving and Communications Systems (PACS) and view stations can display descriptions of the studies found on their system. Consequently, physicians want their own terminology and phrases to be used to describe a particular exam. (The terms “exam” and “study” will be used interchangeably herein.) Given that fact, it would not be beneficial for the imaging system vendor to adopt a particular hospital's set of exam descriptions. One possible solution to the problem of providing a means for adding exam descriptions to images transferred from an imaging system is to provide a simple text field for the user to enter the description manually on the imaging system console. However, this solution is not optimal because the exam descriptions are often codes which are hard to remember or difficult to type. A more desirable approach would be to provide the user with a list of exam descriptions to choose from. One proposed solution would be for the equipment vendor to install a set of configuration files in each imaging system for each hospital, but this would require that too much maintenance be provided by the equipment vendor. Thus there is a need for an infrastructure that would allow each institution to create and manage their own list of exam descriptions.

### SUMMARY OF THE INVENTION

The present invention is a system and a method which enable physicians to digitally attach their own accurate descriptions of a study (e.g., ultrasound imaging of a patient) being performed. The invention allows the user to attach a selected exam description to each image taken during that study.

A first feature of the invention is an exam description management system which provides the user with an interface for creating a list of exam descriptions and then managing the list by adding or deleting entries. Each time a user adds an exam description to the list, the value of that exam description is added to a software engineering structure known as a linked list. Each time the user deletes an exam description, that exam description is removed from the linked list. This linked list is written to the hard disk of the imaging system to maintain its integrity beyond power life.

A second feature of the invention allows the user to select an exam description from the list and add it to the patient study information. Once the user has selected an exam description, they can modify it or use it throughout the course of the study. As a result, each image acquired during the study will have that exam description digitally attached, which description stays attached even if the image file is sent through the imaging machine's DICOM subsystem.

In accordance with a third feature of the invention, the exam description list can be transported from one imaging system to another imaging system. To accomplish this, the user simply saves the list by activating a button on the imaging system console which initiates a procedure whereby all of the system presets, including the exam description list, are saved to a magneto-optical disk (MOD). This MOD can then be taken to another imaging system containing the exam description management software and the presets (including the exam description list) stored on the MOD can be loaded into the new imaging system in a well-known manner.

In accordance with the preferred embodiment of the invention, the exam description management system comprises a user-interface screen having a column of fields. Each field can be filled in with an exam description. At the bottom of the screen is an “Edit” field where the user can type in the entry to be added to the list. After the user has typed in the entry to be added, the user can click on a virtual “Add” button, which causes the entry in the Edit field to automatically appear in the topmost empty field of the exam description list shown on the screen.

### BRIEF DESCRIPTION OF THE DRAWINGS

FIG. 1 is a block diagram showing a conventional ultrasound imaging system of the type which can be programmed to have DICOM capability.

FIG. 2 is a block diagram showing a typical DICOM network.

FIG. 3 is a block diagram generally depicting the hardware and software of an ultrasound imaging system in accordance with the preferred embodiment.

FIG. 4 is a schematic reproducing a “Device Configuration” menu which can be called up on the display monitor during configuration of the imaging system in accordance with the preferred embodiment.

FIG. 5 is a schematic reproducing a “Device Activation” menu which can be used to activate selected configured remote devices in accordance with the preferred embodiment.

FIG. 6 is a schematic reproducing a “New Patient” menu having an empty exam description field in accordance with the preferred embodiment.

FIGS. 7 and 8 are schematics reproducing an “Exam Description” menu and showing the entry of a new exam description in an “Edit” field (FIG. 7) and the transfer of that new entry to the exam description list (FIG. 8) in accordance with the preferred embodiment.

FIG. 9 is a schematic showing the “New Patient” menu with the “Description” field filled in by selecting from an exam description list in accordance with the preferred embodiment of the invention.

FIG. 10 is a schematic depicting a simple (one entry) example of an Exam Description list in accordance with the preferred embodiment of the invention.

FIGS. 11 and 12 are schematics depicting the Exam Description list of FIG. 10 with respective new entries added by alphabetic ordering in accordance with the preferred embodiment of the invention.

FIG. 13 is a schematic depicting deletion of an entry from the Exam Description list shown in FIG. 12 in accordance with the preferred embodiment of the invention.

### DETAILED DESCRIPTION OF THE PREFERRED EMBODIMENTS

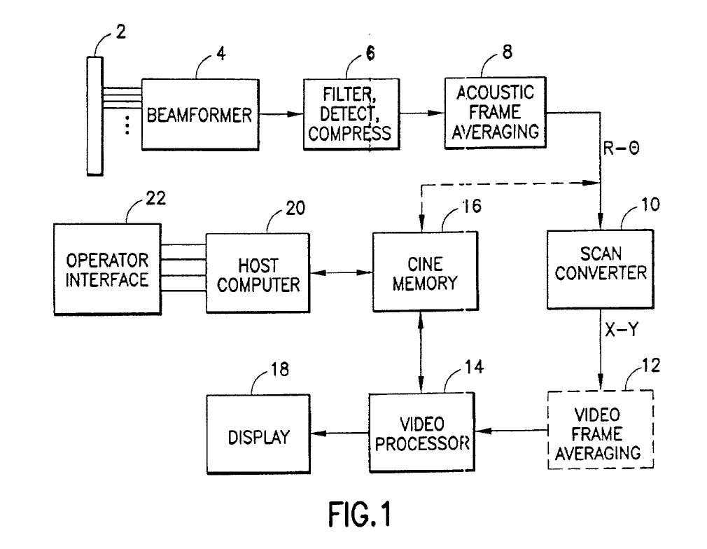

FIG. 1 shows a conventional computerized ultrasound imaging system which can be programmed to communicate with remote devices over a network in conformance with the DICOM standard. The type of imaging system depicted in FIG. 1 creates two-dimensional B-mode images of tissue in which the brightness of a pixel is based on the intensity of the echo return. The basic signal processing chain is as follows.

An ultrasound transducer array 2 is activated to by a transmitter in a beamformer 4 to transmit an acoustic burst which is focused at a point along a scan line. The return RF signals are detected by the transducer elements and then dynamically focused to form a receive beam by a receiver in the beamformer 4. The receive beamformer output data (I/Q or RF) for each scan line is passed through a B-mode processing chain 6, which preferably includes demodulation, filtering, envelope detection, logarithmic compression and edge enhancement.

Depending on the scan geometry, up to a few hundred receive vectors may be used to form a single acoustic image frame. To smooth the temporal transition from one acoustic frame to the next, some acoustic frame averaging 8 may be performed before scan conversion. In general, the log-compressed display data is converted by the scan converter 10 into X-Y format for video display. On some systems, frame averaging may be performed on the X-Y data (indicated by dashed block 12) rather than the acoustic frames before scan conversion, and sometimes duplicate video frames may be inserted between acoustic frames in order to achieve a given video display frame rate. The scan-converted frames are passed to a video processor 14, which maps the video data using a gray-scale mapping. The gray-scaled image frames are then sent to a video monitor 18 for display.

System control is centered in a host computer 20, which accepts operator inputs through an operator interface 22 and in turn controls the various subsystems. (In FIG. 1, only the image data transfer paths are depicted.) The operator interface comprises a keyboard, a trackball, a multiplicity of pushbuttons, and other input devices such as sliding and rotary knobs and a “rocker” switch.

During imaging, a long sequence of the most recent images are stored and continuously updated automatically in a cine memory 16. Some systems are designed to save the R-θ acoustic images (this data path is indicated by the dashed line in FIG. 1), while other systems store the X-Y video images. The image loop stored in cine memory 16 can be reviewed via trackball control, and a section of the image loop can be selected for hard disk storage.

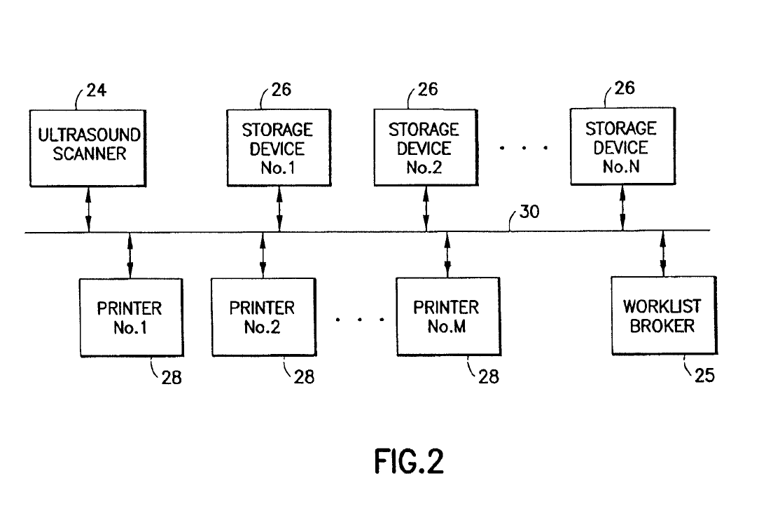

FIG. 2 generally depicts a simplified DICOM network having an ultrasound scanner 24, a worklist broker (e.g., an RIS) 25, N storage devices 26, and M printing devices 28, all connected to a local area network (LAN) 30. It will be readily appreciated that this diagram represents a simplified example of a DICOM network and that an actual DICOM network in the real world will have many more devices connected to the LAN, including modalities other than ultrasound imaging systems. The present invention is incorporated in an ultrasound imager (scanner) having the built-in capability to communicate with any one or more of the devices 25, 26 and 28 in conformance with the DICOM requirements. As used herein, the term “storage device” includes, but is not limited to, a picture archiving and communications system (PACS) or a viewing station.

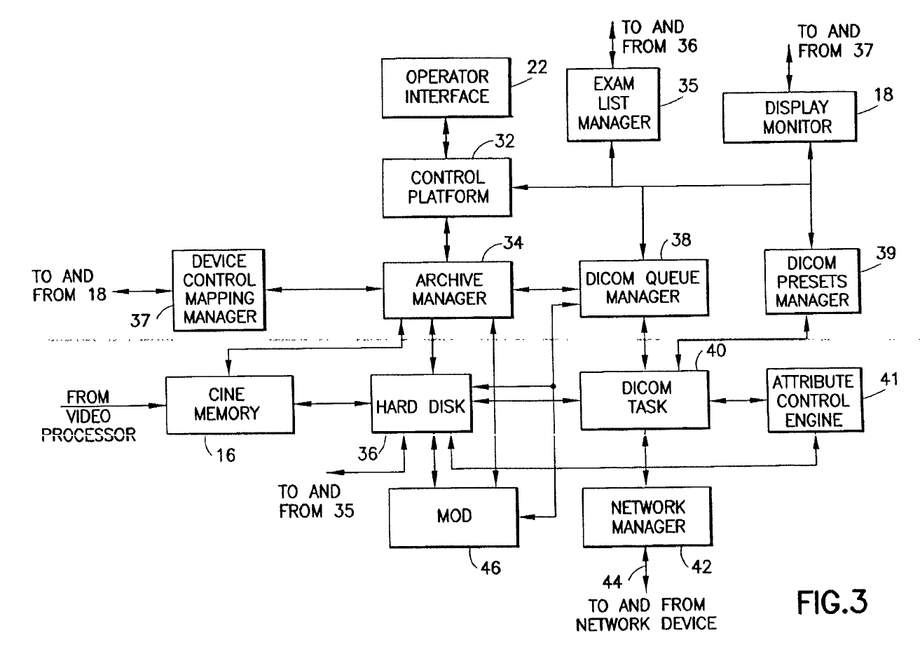

A portion of the ultrasound imager is generally depicted in FIG. 3. At the outset it should be appreciated that all of the blocks depicted in FIG. 3, with the exceptions of the cine memory 16, the display monitor 18 and the operator interface 22, are preferably, but not necessarily, incorporated in the host computer (depicted in FIG. 1 as block 20). It should be further appreciated that blocks 32, 34, and 37-42 in FIG. 3 are preferably, but not necessarily, implemented as software.

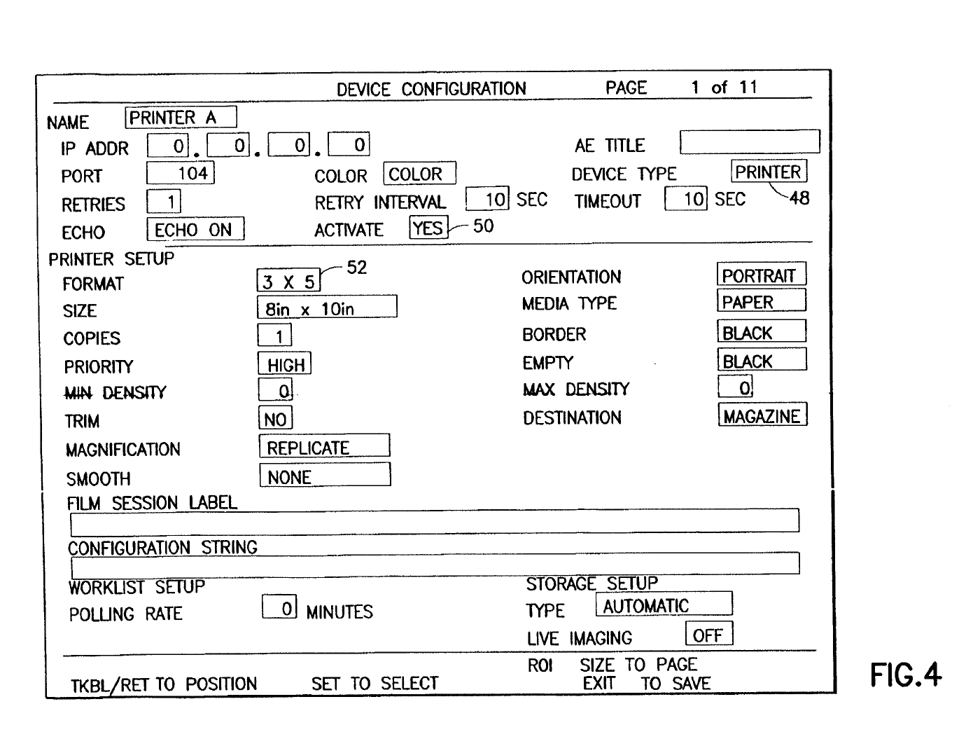

In the system depicted in FIG. 3, commands inputted via the operator interface 22 are detected and processed by a control platform 32. In return, the control platform will provide signals to the operator interface which activate various visual indicators on the operator interface to indicate the status of various functions. In response to manipulation of the appropriate key or appropriate set of keys by the operator, the DICOM presets manager 39 will display a “Device Configuration” menu (shown in FIG. 4) on the display monitor 18. The operator then enters configuration data for the first destination remote device (e.g., “Printer A” in FIG. 4) via the operator interface. Depending on whether the device being configured is a printer or storage device, the Device Type field 48 on the Device Configuration menu will be filled in with either a “Printer” or a “Storage” entry. If the device being configured is a printer which prints multi-image film sessions, then the Format field 52 in the “Printer Setup” section on the Device Configuration menu will be filled in with numbers indicating the printing format of the multi-image printer (e.g., “3×5” in the case of Printer A). For single-image printers, the entry in Format field 52 will be “1×1”. A separate page of the “Device Configuration” menu will be “filled in” for each remote device which the operator wishes to configure.

The imager shown in FIG. 3 is designed to communicate with a configured remote device only if that device has been “activated”. Activation causes the DICOM presets manager 39 to configure one of a multiplicity of DICOM tasks 40 in accordance with configuration data entered into the system for the associated remote device. That particular DICOM task will thereafter remain configured for that type of remote device until reconfigured for a different device. Other DICOM tasks are configured for other remote devices.

One way of activating a remote device is to click on the Activate field 50 on the Device Configuration menu (see FIG. 4) to toggle the “Activate” state on. A second click on field 50 will toggle the “Activate” state off, and so forth. Alternatively, the operator can call up the Device Activation menu shown in FIG. 5, which is sent to the display monitor by the DICOM presets manager 39. The Device Activation menu comprises a list of the names of all configured remote devices, whether activated or not. A respective Activation field 54 is associated with each named device. Each Activation field 54 is a virtual representation of an Activation toggle switch. In other words, the imager is programmed with software which allows the user to activate and de-activate each configured device by simply clicking on its associated Activation field. A Yes or No is displayed in the Activation field to provide a visual indication of whether the remote device is activated. FIG. 5 assumes that the remote devices named Printer A, Printer B and Storage A have been configured and activated, while the remote devices named Printer X, Printer Y and Storage B have been configured and not activated.

Referring again to FIG. 3, the preferred embodiment is equipped with a plurality of Print/Store buttons on the operator interface 22. Each Print/Store button can be configured by the device control mapping manager 37 to initiate image transfer to more than one remote device, e.g., when a particular Print/Store button is pressed, the computer will send the corresponding acquired image to all activated remote devices configured for that button. The device control mapping manager is programmed to retrieve a Device Control menu (not shown), which is a virtual representation of the various configurations for the Print/Store buttons, from the hard disk 36 and send it to the display monitor 18. Each control state can be configured so that the data of the acquired image is expressed as either color intensity values or gray-scale intensity values; so that the acquired image will be stored on the hard disk or the MOD; so that the acquired image will be transferred to one or more activated remote devices; or any combination of these options. Each Print/Store button configuration can be set via the operator interface. For each remote device configured to a particular Print/Store button, pressing that button after freezing an image will cause the associated DICOM task to retrieve an image file having a copy of that image from the hard disk and convert that image file to a DICOM object compatible with the associated remote device.

In accordance with the preferred embodiment, the device control mapping manager 37 (see FIG. 3) constructs a mapping of DICOM tasks (configured for respective remote devices) to Print/Store buttons. In other words, when the operator interacts with the Device Control menu (not shown) to configure a Print/Store button to a particular remote device, the device control mapping manager then identifies the DICOM task corresponding to that remote device and includes it in the device control mapping. The device control mapping manager 37 provides the device control mapping to the archive manager 34. When the archive manager later receives a posting from the control platform 32 that a particular Print/Store button has been pressed, the archive manager 34 will then refer to the device control mapping and determine the DICOM tasks associated with that button from the mapping. The archive manager 34 then advises the DICOM queue manager 38 which DICOM tasks 40 need to construct objects incorporating the selected image frame. The DICOM queue manager 38 then copies that image file once for each task and, if the remote devices are storage devices or single-image printers, adds a job element to the Active Queue of each task. For multi-image printers, the DICOM queue manager 38 need only add another image file name to the Image File Name field of an existing job element in the queue.

Although FIG. 3 depicts only one DICOM task, in accordance with the preferred embodiment, the imager is programmed with multiple DICOM tasks. In the preferred embodiment, one DICOM task is dedicated to worklist management and ten DICOM tasks can be configured to convert image files into either DICOM print objects or DICOM storage objects. It should be appreciated, however, that the present invention is not restricted to having ten DICOM tasks for printing and storage. In response to pressing of a Print/Store button which is configured for multiple remote devices, a corresponding multiplicity of DICOM tasks will be started substantially simultaneously. These concurrently running tasks are performed using conventional multi-tasking principles.

In accordance with the preferred embodiment, the host computer of the imager is programmed to store in memory the configuration data input via the Device Configuration menu shown in FIG. 4. For each configured remote device which is activated, a respective DICOM task is configured by the DICOM presets manager 39 in accordance with the stored configuration data. In other words, each DICOM task is partly defined by the inputs to the corresponding page of the Device Configuration menu. In particular, each DICOM task is programmed to convert an image file into a print object for printers, if “Printer” was entered in the Device Type field 48 (see FIG. 4) on the Device Configuration menu, and into a storage object for storage devices, if “Storage” was entered in the Device Type field. In the case where more than one remote device is designated to receive the same image, the associated DICOM tasks will convert respective copies of that image into respective DICOM objects acceptable to the respective remote devices.

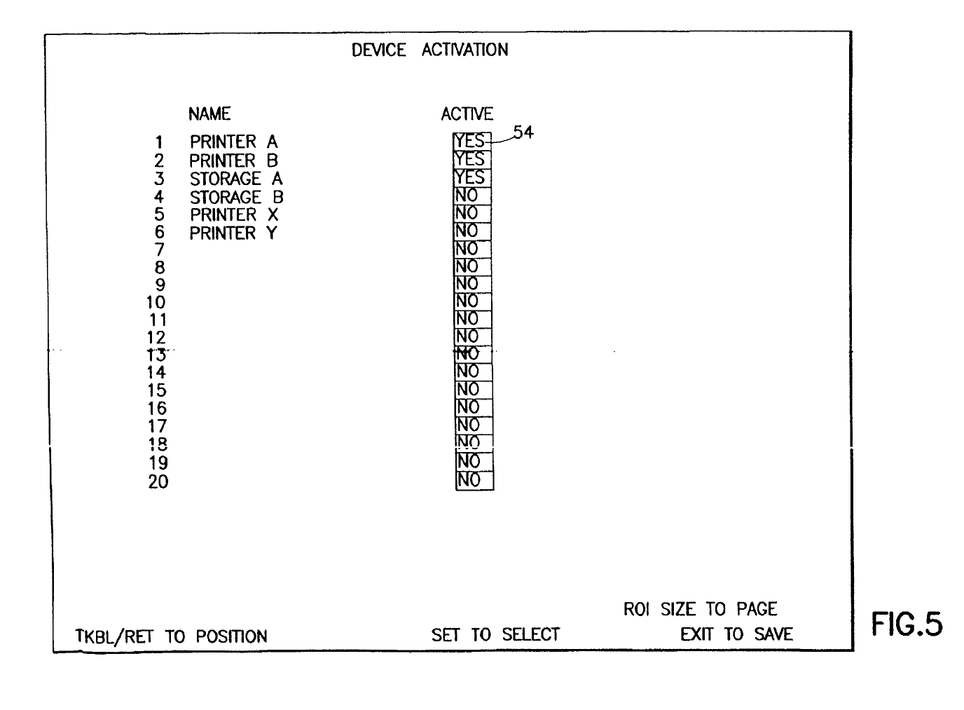

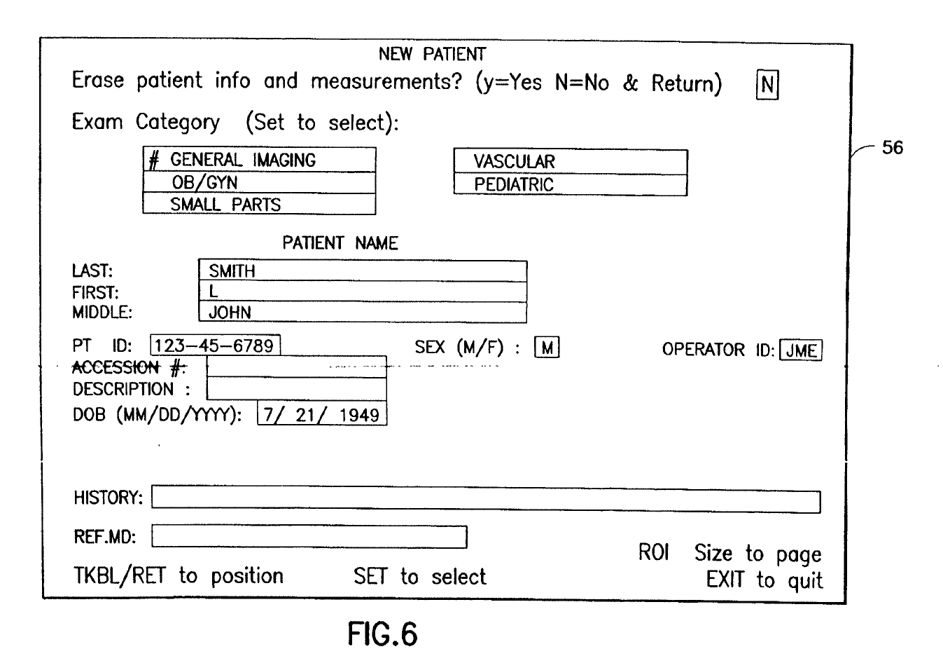

At the beginning of every exam the system user (sonographer or sonologist) pushes a “New Patient” button, causing a “New Patient” menu (shown in FIG. 6) to appear on the screen of the display monitor. The user then enters information about the patient (e.g., name, patient identifier, accession number, birthdate, etc.). When data entry is completed, the user exits the menu. At this time, a DICOM Study Instance unique identifier (UID) is created. This Study Instance UID forms the base of a Service Object Pair (SOP) Instance UID which tells the receiving DICOM device (SCP) that the image received belongs to a particular patient. Every image taken by the user, after exiting the “New Patient” menu, will have the same UID.

The examination may then begin. The user will scan the patient as needed. The user, at any time, can freeze the image and take a snapshot of that image to send to a remote device. If the receiving device is a printer, the Instance UID is not of any concern. Printers may be configured to put more than one image on a piece of film (e.g., 3×5=15 images). If this were the case, the user would normally take all 15 images before sending the completed film session to the printer.

If the receiving device is a storage device, then the SOP Instance UID will direct the image to that patient's folder of images. Storage devices receive images one at a time. The typical method of image transfer to a storage device is as follows: the DICOM task opens an association (connection) with the receiving storage device; transfer negotiations occur; the image is transferred; and the association is closed. Alternatively, the imager can be configured to open the association once and keep it open throughout the entire exam. In the latter case, the association is opened upon the sending of the first image and is closed by pressing an “End Exam” key.

The image transfer procedure used in the preferred embodiment will be described in more detail with reference to FIG. 3. In response to a request from the operator to archive a frozen image, the control platform 32 sends an “Image Store” instruction to the archive manager 34. In response to the “Image Store” instruction, the archive manager retrieves the frozen image from cine memory 16 and stores it either on the hard disk 36 or on the MOD 46, depending on the system operator's selection.

In addition, the system operator may request that the frozen image be sent to an activated remote device for printing or storage by pressing the appropriate Print/Store button. In response to a request from the operator to transfer a frozen image to a remote device, the control platform 32 sends an “Image Send” instruction to the archive manager 34. The archive manager 34 retrieves the frozen image from the cine memory 16 and stores it in a file on the hard disk 36. The file includes the image pixel data as well as certain attribute data, such as patient name, patient ID, gray-scale or color image, number of rows and columns of pixels, etc. Then the archive manager 34 notifies the DICOM queue manager 38 of the image to be transferred and the destination remote device that image (and subsequent images of the same job) will go to. Next the queue manager 38 copies the image to another location on the hard disk and gives that copied image a new file name. If the pressed Print/Store button is configured for multiple remote devices, then the queue manager 38 will store multiple copies of the frozen image in multiple files, i.e., a separate copy of the frozen image for each remote device designated as a destination for that image.

In accordance with the DICOM standard, each DICOM task is designed to convert an image file, comprising image frame data and attribute data, into a DICOM-formatted object, also comprising image frame and attribute data. That DICOM object must conform not only to the DICOM standards, but also to the attribute require-ments of the remote device destined to receive that DICOM object. The attribute requirements for each DICOM task are stored in a respective Attribute Control File stored on the hard disk. Each Attribute Control File specifies the attributes which should be included and the tag numbers which should be used in a data object to be transmitted to a particular remote device to ensure compatibility with that device.

In accordance with a further feature of the preferred embodiment, the host computer is programmed with an Attribute Control Engine 41 which controls which attributes to include and which attribute names and values to associate with which attribute tags in the DICOM objects constructed by each DICOM task 40. When the system is powered up, the Attribute Control Engine 41 reads the Attribute Control Files from the hard disk 36 and writes them into system memory. These Attribute Control Files are kept in system memory for the duration of the power cycle. Each Attribute Control File comprises many lines for setting up the DICOM attributes. One line is needed to set up one DICOM attribute. The format of each line is as follows:

[Module Name][Tag Number][Sequence Number][Format String]

The module name specifies the DICOM module which the attribute on that line belongs to. The module name is a defined term. The tag number specifies a particular attribute included in that module. Some DICOM attributes have the sequence of the subset of some DICOM attributes. The sequence number specifies the sequence which the attribute belongs to. The format string specifies how the data value of the attribute should be created.

Each DICOM task 40 receive instructions from the Attribute Control Engine 41 concerning which attributes to include and which tag numbers to use in the DICOM object being constructed by that DICOM task. First, the DICOM task 40 asks the Attribute Control Engine 41 whether a particular attribute should be included in the DICOM object. The Attribute Control Engine 41 refers to the Attribute Control File to determine whether the attribute should be included. If the attribute should not be included, the Attribute Control Engine 41 advises the DICOM task accordingly. The DICOM task 40 then proceeds to the next attribute. If the attribute should be included in the DICOM object under construction, the Attribute Control Engine 41 so advises the DICOM task 40. The DICOM task then asks the Attribute Control Engine 41 whether the value of that attribute should be obtained from the image file which is being converted or whether the attribute value should be obtained from the Attribute Control File. Again the Attribute Control Engine 41 refers to the Attribute Control File. If the attribute value should be taken from the image file, the Attribute Control Engine so advises the DICOM task. Alternatively, if the attribute value should be taken from the Attribute Control File, the Attribute Control Engine 41 retrieves that attribute value and sends it to the DICOM task 40.

The foregoing procedure is repeated for each attribute associated with the particular function, i.e., construction of a print object or storage object, being performed by a particular DICOM task. In other words, if the DICOM task is performing the storage function, then the DICOM task will query the Attribute Control Engine with regard to only those attributes which are relevant to the storage function. Likewise for the print function. In response to each query from the DICOM task 40 regarding a particular attribute, the Attribute Control Engine 41 will read only that line in the Attribute Control File corresponding to that attribute.

Referring again to FIG. 3, each DICOM task 40 sends its DICOM object in proper format to the corresponding destination remote device via the network manager 42 and the port 44. The DICOM tasks run concurrently and independently of each other in accordance with conventional multi-tasking principles. Jobs which are waiting to be converted into DICOM objects by a DICOM task are queued. The queue is managed by a DICOM queue manager 38.

Referring still to FIG. 3, the first job in the queue is sent by the queue manager 38 to the DICOM task 40 identified by the Task ID and corresponding to the destination remote device for that first job. When the DICOM task 40 receives a job from the queue, it will read a pointer which contains the file name of the image to be formatted and transferred to the destination remote device. The DICOM task 40 then retrieves the image from the named file on the hard disk and reformats it into the appropriate DICOM object in accordance with the instructions from the Attribute Control Engine 41. In addition to the pixel data for the image being transferred, the DICOM object constructed by the DICOM task will include attribute data in DICOM format. If the remote device is a storage device, the DICOM task will also attach a UID to the image.

Next the DICOM task 40 will open a connection (association) to the destination remote device and negotiate a syntax. In particular, the DICOM task 40 sends a request via the network manager 42 and a port 44 that an association with the configured remote device be opened. If the remote device responds affirmatively and if a communications syntax is agreed upon, the association is opened. Once the association is open and assuming that a channel on the network is available (i.e., the network is not busy), the image is sent from the imager onto the network, again via network manager 42 and port 44. If the destination remote device sends back a message that the image transfer was successful, then the DICOM task 40 notifies the queue manager 38. The queue manager then removes the entry for the successfully transferred image from the queue and deletes that image file from the hard disk 36.

In accordance with the preferred embodiment of the invention, one of the attributes included in the transferred data object is the Exam (Study) Description attribute, which comprises a name, a value and a tag number. The Exam Description tag is important to receiving devices such as the PACS and viewing stations so that they can display the exam description entered at the imaging system by the physician. The Attribute Control Engine can map the value of the exam description, picked from a list of exam descriptions, to any valid DICOM tag number. In accordance with the preferred embodiment of the invention, the imaging system user is able to perform the following tasks: (1) create a list of exam descriptions; (2) manage that list by adding or deleting exam descriptions; (3) select from the list an exam description to be used in the current study and to be passed through the DICOM subsystem; and (4) transport the exam description list to another imaging system.

The imaging system user can add exam descriptions to the exam description list by going to the user-interface screen known as the New Patient screen, shown in FIG. 6, i.e., by pressing a New Patient button on the imaging system console (not shown). The New Patient screen is sent to the display monitor 18 by the control platform 32. One of the fields, designated by reference numeral 56, on the New Patient screen is called “Description”. Field 56 holds the value of the exam (study) description attribute, which can be incorporated by the DICOM task 40 into any data object to be transferred.

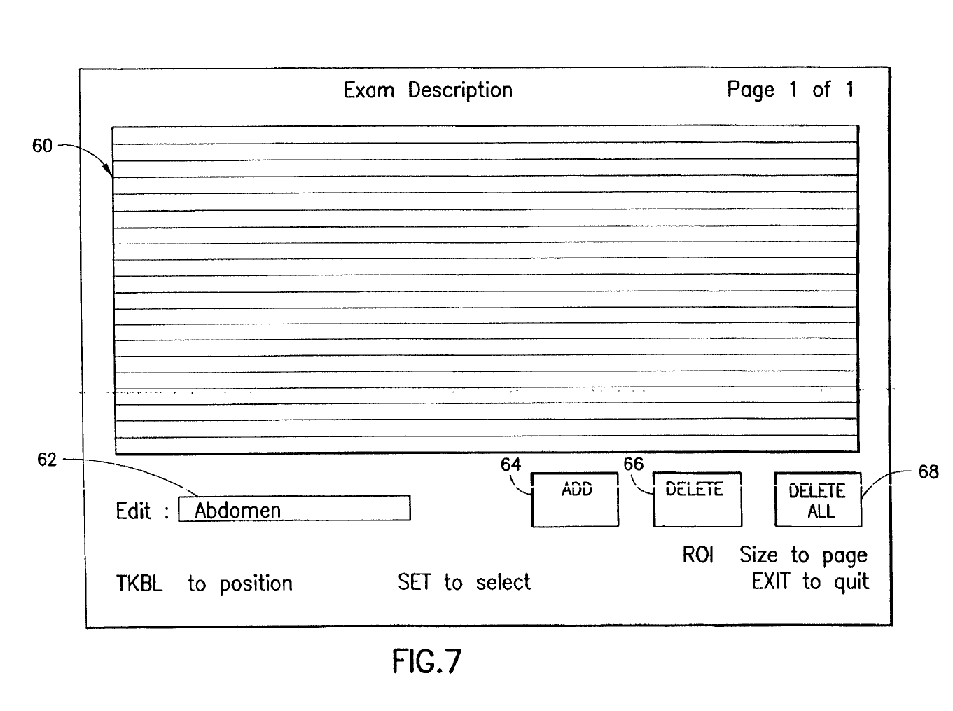

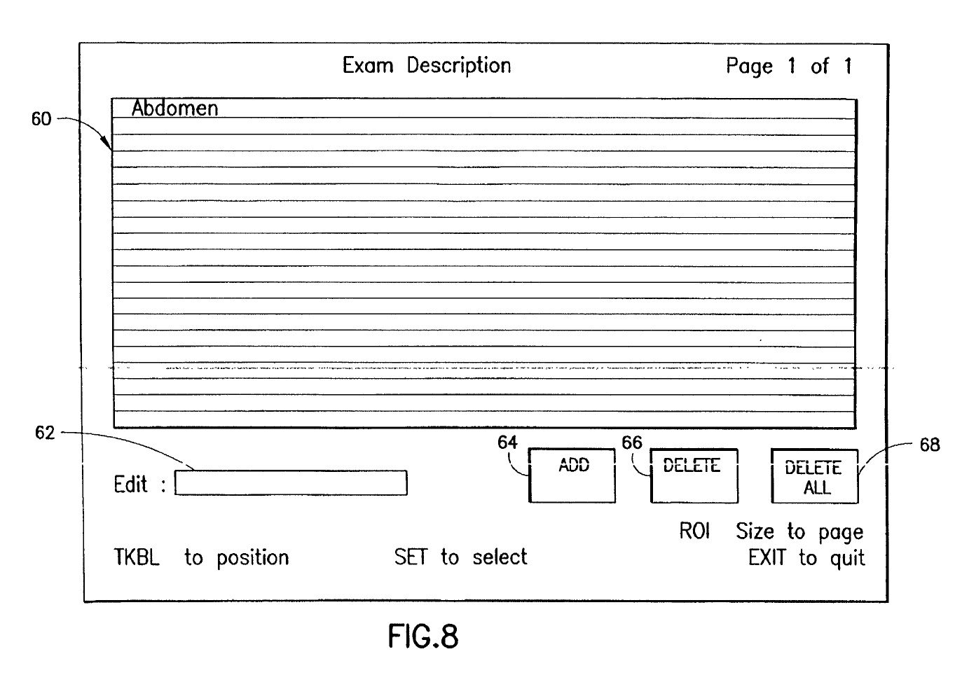

In accordance with the preferred embodiment of the invention, the user then presses another input device, e.g., a “rocker” switch, on the imaging system console to change screens to the Exam Description screen, shown in FIG. 7, which is sent to the display monitor 18 by the exam list manager 35 (see FIG. 3). The Exam Description list shown in FIG. 7 is empty, but the screen comprises a single column of fields 60, each field being able to hold one exam description. The list can hold a multiplicity, e.g., up to 99, of exam descriptions. At the bottom of the screen there is an “Edit” field 62 where the user can type the exam description to be added. Once the user has typed in an entry to be added, the user can activate, e.g., by placing a cursor over and clicking on, a virtual button 64 labeled “Add” and the new description will appear in the topmost empty field on the screen. As an example, FIG. 7 shows the exam description “Abdomen” entered in the Edit field 62. Upon activation of the Add button 64, the exam description “Abdomen” is transferred from the Edit field 62 to the first available field 60 in the Exam Description list, as shown in FIG. 8. To delete an entry from the Exam Description list, the entry must be typed exactly into the Edit field 62 and then the user activates a virtual Delete button 66. In response to activation of the Delete button, the item entered in the Edit field is removed from the Exam Description list. To remove all entries from the Exam Description list, the user simply activates a virtual Delete All button 68 on the Exam Description screen. To modify an entry on the Exam Description list, the user must first delete the unmodified entry on the list and then add the modified version to the list, using the procedures previously described. The linked list is written to the hard disk 36 of the imaging system to maintain its integrity beyond power life.

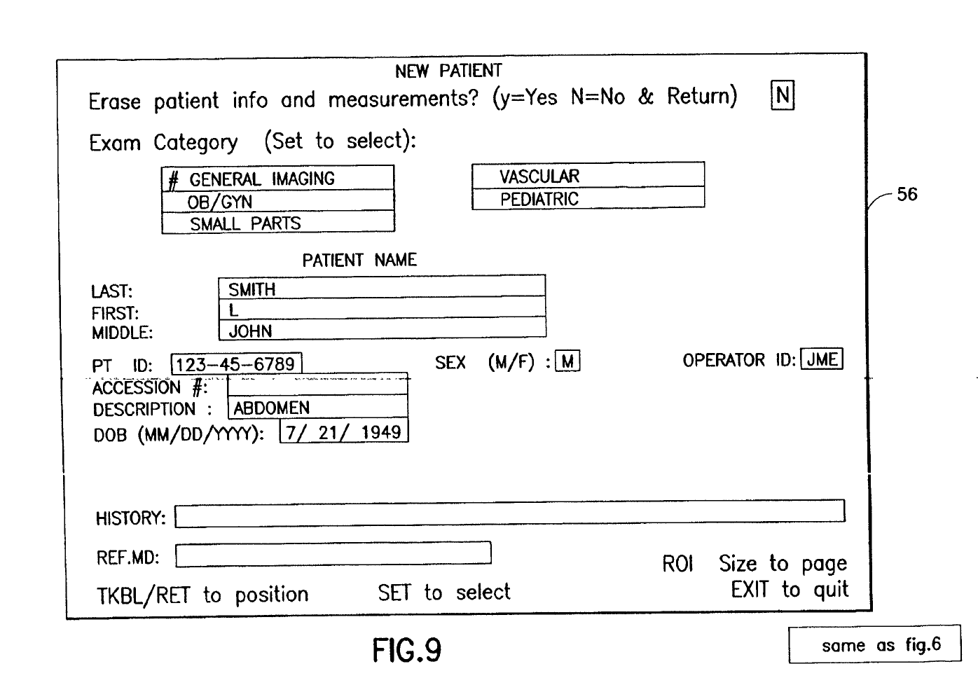

At any time, the user can select an exam description to be used with the study to be performed. When a user begins an exam on the imaging system, the user goes to the New Patient screen shown in FIG. 6. There the user fills out the appropriate patient demographic information (i.e., patient name, birthdate, patient ID, etc.) along with certain exam information. As previously described, the exam description will be entered in Description field 56. The user can either manually type an exam description in field 56 or press the “rocker” switch on the imaging system console to change screens to the Exam Description screen, shown in FIG. 8. On the Exam Description screen, the user only needs to use another input device, e.g., a trackball, to highlight the exam description desired (in this example, “Abdomen”). Once the selected entry is highlighted, the user presses the Set button (not shown) on the imaging system console and the user interface screen will change from the Exam Description screen shown in FIG. 8 back to the New Patient screen shown in FIG. 9, filling in the Description field 56 with the value selected from the Exam Description screen, i.e., transferring the exam description attribute value from the exam list manager 35 to the control platform 32. The user can still modify the Description field further if so desired, for example, by manually adding text after the word “Abdomen” in field 56. At this time the user can continue to fill out the rest of the New Patient screen fields. Depending on the contents of the attribute control file corresponding to the remote device being communicated with, the exam description value can be sent from the control platform to the DICOM task 40 which is constructing data objects to be sent to that remote device.

In accordance with the preferred embodiment of the invention, the exam description list is a software structure known as a linked list. Upon first usage of this feature, the linked list is empty. As a user adds an exam description, an element is allocated in memory, and the value (the value being any alphanumeric character including special characters found on the keyboard of the imaging system) of the Edit field (62 in FIG. 7) is copied into the description part of that newly allocated element. The element is then added to the linked list by setting the pointer of that element to the next element in the list. An empty list consists of only one element which contains the value NULL and points to nothing. This element will always serve as the end of the list.

FIG. 10 depicts a list containing only one exam description entry, namely, “carotid”. The arrow represents the pointer part of the element that is pointing to the next element in the list, which in this example is the NULL element.

As new entries are added, they are inserted into the list based on alphabetical order. When the user enters a new exam description in the Edit field 62 and clicks on the Add button 64 (shown in FIG. 7), the imaging system will take the value entered in the Edit field and alphabetically compare that to the first entry in the list. If the new entry alphabetically comes before the first entry, then the new entry's pointer is set to point to the original first entry. FIG. 11 depicts an example wherein the entry “abdomen” has been added to a list which previously contained only the entry “carotid”.

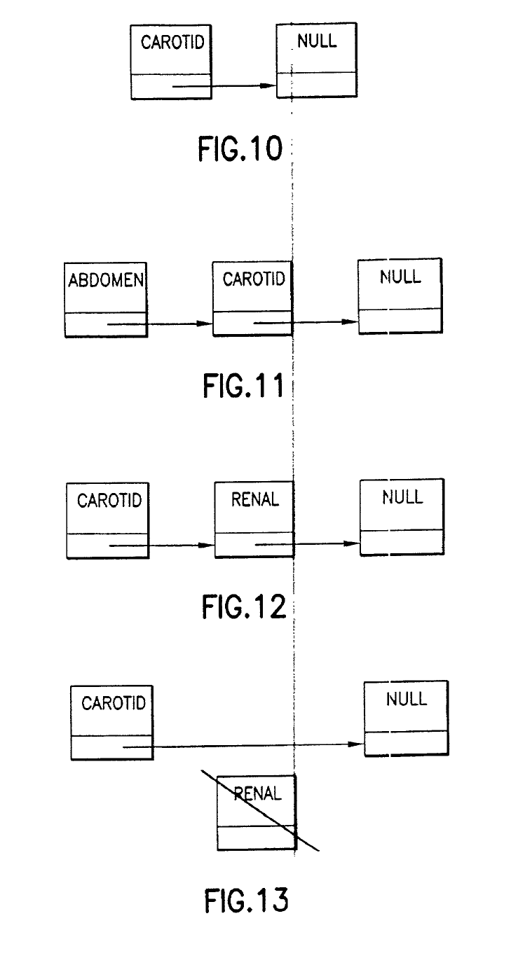

If the new entry alphabetically comes after the first (and only) entry, then the first entry's pointer is set to point to the new entry and the new entry's pointer is set to point to the last element (i.e., NULL) , as shown in FIG. 12. Obviously, when the list comprises more than one exam description entry, each entry on the list must be compared to the new entry until an entry on the list is found which alphabetically follows the new entry. The new entry will then be inserted between the list entry which alphabetically follows the new entry and the alphabetically preceding list entry.

As new entries are added, the search for placing the new entry in the list always starts at the first element. Since the list is always sorted alphabetically, once the system finds the element in the list having a value which is alphabetically greater than the value of the new entry, it has found the position in the linked list where the new entry should be placed. NULL, the last entry in the list, will always be greater, because it is the end of the list.

Once a list has been created, the user is free to use it anytime. The exam description list displayed on the user-interface screen comprises the description values of each linked list entry. Since the list is alphabetically ordered, the list on the screen will appear alphabetically ordered.

The user may also modify the list at any time. To add to the list, the user simply types a description in the Edit field and clicks on the Add button. The process described above is then repeated to find the place where the added entry should be inserted.

To delete an exam description from the list, the user simply selects the entry to be removed by typing the description in the Edit field and clicking on the Delete button. The imaging system reads the value of the Edit field, just as it would in the adding process, and compares that value, starting at the beginning, to every value found in the linked list. If the imaging system does not find a match, a message appears on the display screen stating that the value to be deleted was not found in the exam description list. If the value to be deleted was found in the linked list, then the imaging system removes that element from the list. To do that, the imaging sets the pointer of the element preceding the entry to be deleted to point to the element after the entry to be deleted. Then the system de-allocates that memory for that element. FIG. 13 shows an example of a deleted element. The new list is displayed on the screen after the element has been deleted.

To modify an existing entry in the list, the user will have to delete the existing entry and add the modified entry.

In accordance with a further feature of the preferred embodiment, the exam description list can be transported from one imaging system to another imaging system. To accomplish this, the user simply saves the list by activating a button on the imaging system console which initiates a procedure whereby all of the system presets, including the exam description list, are read from the hard disk 36 and saved to the MOD 46 (see FIG. 3). This MOD can then be taken to another imaging system containing the exam description management software and the presets (including the exam description list) stored on the MOD can be loaded into the new imaging system in a well-known manner.

While the invention has been described with reference to preferred embodiments, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore it is intended that the invention not be limited to the particular embodiment disclosed as the best mode contemplated for carrying out this invention, but that the invention will include all embodiments falling within the scope of the appended claims.

1. An imaging system comprising:
a networking port for communicating with a remote device on a network;
an image acquisition subsystem for acquiring frames of image data;
an operator interface for inputting operating instructions;
a display screen;
an exam description list manager programmed to manage a list of exam descriptions based on operating instructions received via said operator interface and then control said display screen to display said stored list of exam descriptions;
memory storing acquired frames of image data in respective image files and storing said list of exam descriptions;
an object constructing task for constructing a data object comprising a frame of image data from one of said image files and an associated exam description;
means for selecting said associated exam description from said list; and
a network manager for transferring said data object from said object constructing task to said networking port destined for said remote device.

2. The system as recited in claim 1, wherein said exam description list manager is further programmed to insert a new exam description in alphabetical order in said list in response to entry of said new exam description in an Edit field on said display screen and activation of a virtual Add button on said display screen.

3. The system as recited in claim 1, wherein said exam description list manager is further programmed to delete an exam description in said list in response to entry of said exam description in an Edit field on said display screen and activation of a virtual Delete button on said display screen.

4. The system as recited in claim 1, wherein said exam description list manager is further programmed to delete all exam descriptions in said list in response to activation of a virtual Delete All button on said display screen.

5. An imaging system comprising:
an operator interface for inputting operating instructions;
a display screen;
means for controlling said display screen to display a user-interactive menu comprising a multiplicity of aligned fields for displaying a list of exam descriptions, one exam description per field, an edit field for entry of an exam description via said operator interface, and a virtual button activatable via said operator interface for initiating a list edit function;
means for editing said list of exam descriptions based on said entry in said edit field and in accordance with said list edit function in response to activation of said virtual button; and
memory storing said list of exam descriptions.

6. The system as recited in claim 5, wherein said list of exam descriptions comprises a linked list of alphabetically ordered elements.

7. The system as recited in claim 5, wherein said edit list function comprises entry addition, and said list editing means comprise means for inserting said edit field entry in alphabetical order in said list.

8. The system as recited in claim 5, wherein said edit list function comprises entry deletion, and said list editing means comprise means for deleting said edit field entry from said list.

9. The system as recited in claim 5, wherein said edit list function comprises deletion of all list entries, and said list editing means comprise means for deleting all entries in said list.

10. The system as recited in claim 5, further comprising:
a networking port for communicating with a remote device on a network;
an image acquisition subsystem for acquiring frames of image data;
memory storing acquired frames of image data in respective image files;
an object constructing task for constructing a data object comprising a frame of image data from one of said image files and an associated exam description selected from said list displayed on said user-interactive menu via said operator interface; and
a network manager for transferring said data object from said object constructing task to said networking port destined for said remote device.

11. An imaging system comprising:
an operator interface for inputting operating instructions;
a display screen;
computer memory; and
a computer programmed to perform the following steps:
(a) controlling said display screen to display a user-interactive menu comprising a multiplicity of aligned fields for displaying a list of exam descriptions, one exam description per field, an edit field for entry of an exam description via said operator interface, and a virtual button activatable via said operator interface for initiating a list edit function;
(b) editing said list of exam descriptions based on said entry in said edit field and in accordance with said list edit function in response to activation of said virtual button; and
(c) storing said list of exam descriptions in said memory

12. The system as recited in claim 11, wherein said list of exam descriptions comprises a linked list of alphabetically ordered elements.

13. The system as recited in claim 11, wherein said edit list function comprises entry addition, and said editing step comprises the step of inserting said edit field entry in alphabetical order.

14. The system as recited in claim 11, wherein said edit list function comprises entry deletion, and said editing step comprises the step of deleting said edit field entry from said list.

15. The system as recited in claim 11, wherein said edit list function comprises deletion of all list entries, and said editing step comprises the step of deleting all entries in said list.

16. The system as recited in claim 11, further comprising a networking port for communicating with a remote device on a network, wherein said computer is further programmed with:
an image acquisition subsystem for acquiring frames of image data;
an object constructing task for constructing a data object comprising an acquired frame of image data and an associated exam description selected from said list displayed on said user-interactive menu via said operator interface; and
a network manager for transferring said data object from said object constructing task to said networking port destined for said remote device.

17. An imaging system comprising:
an operator interface for inputting operating instructions;
a display screen;
an exam description list manager programmed to manage a list of exam descriptions based on operating instructions received via said operator interface and then control said display screen to display said stored list of exam descriptions; and
memory storing said list of exam descriptions.

18. The system as recited in claim 17, wherein said exam description list manager is further programmed to insert a new exam description in alphabetical order in said list in response to entry of said new exam description in an Edit field on said display screen and activation of a virtual Add button on said display screen.
